(19) United States
(12) Patent Application Publication
(10) Pub. No.: US 2012/0236702 A1
(43) Pub. Date: Sep. 20, 2012

(54) METHOD OF CONTROLLING MECHANICAL MECHANISMS OF ELECTRONIC DEVICE FOR PEAK POWER/CURRENT REDUCTION

(76) Inventor: Yao-Lung Chuang, New Taipei City (TW)

(21) Appl. No.: 13/481,941

(22) Filed: May 28, 2012

Related U.S. Application Data
(63) Continuation-in-part of application No. 12/986,194, filed on Jan. 7, 2011.
(60) Provisional application No. 61/356,653, filed on Jun. 21, 2010.

(51) Int. Cl. G11B 15/18; G11B 19/20; G11B 7/09

(52) U.S. Cl. 369/215.1; 369/176; 369/266; G9B/15.021; G9B/7.062; G9B/19.027

(57) ABSTRACT

To prevent the peak power/current consumption from exceeding a permitted level when more than one active mechanical mechanism of an electronic device (e.g., an optical storage apparatus) is involved in accomplishing a particular task, a method of controlling the electronic device is provided. The electronic device has a plurality of mechanical mechanisms including at least a first mechanical mechanism and a second mechanical mechanism. The method includes following steps: driving the first mechanical mechanism by applying a first control signal to the first mechanical mechanism; driving the second mechanical mechanism by applying a second control signal to the second mechanical mechanism; comparing the first control signal with a first predetermined threshold, and accordingly generating a first comparison result; and selectively adjusting the second control signal according to at least the first comparison result.

### CROSS REFERENCE TO RELATED APPLICATIONS

This continuation-in-part application claims the benefit of co-pending U.S. application Ser. No. 12/986,194 (filed on Jan. 7, 2011), which claims the benefit of U.S. provisional application No. 61/356,653 (filed on Jun. 21, 2010). The entire contents of the related applications are incorporated herein by reference.

### BACKGROUND

The disclosed embodiments of the present invention relate to controlling an electronic device, and more particularly, to a method of controlling mechanical mechanisms of an electronic device, such as an optical storage apparatus (e.g., an external optical disc drive), for peak power/current reduction.

Optical storage apparatuses, such as optical disc drives, become popular due to optical storage media with low cost and high storage capacity. For example, optical disc drives are commonly used in the computer systems. In general, an optical disc drive has a plurality of mechanical mechanisms employed for rotating a loaded optical disc, moving a sled on which an optical pick-up unit (OPU) is disposed, controlling tracking and focusing of a laser spot irradiated by the OPU on the loaded optical disc, etc. However, when multiple mechanical mechanisms are all active at the same time, the power/current consumption is inevitably high. In a worst case, the peak power/current consumption may exceed the maximum level that the power source of the optical disc drive can afford. It is possible that the optical disc drive may fail to work normally when the power/current consumption of the optical disc drive is not well controlled.

In addition, it is possible that the optical disc may have defects caused by dirt and/or scratch. When the OPU is accessing a defect area of the optical disc, the power/current consumption of the tracking servo control and the focus servo control may be instantly increased in response to large control effort made to stabilize the data read/write operation. When the sled motor is increasing the moving speed of the sled or the spindle motor is increasing the rotational speed of the spindle at the same time, the peak power/current consumption may exceed the maximum level that the power source of the optical disc drive can afford.

Thus, there is a need for an innovative design which can effectively reduce the power/current consumption of an optical storage apparatus.

### SUMMARY

In accordance with exemplary embodiments of the present invention, a method of controlling mechanical mechanisms of an electronic device, such as an optical storage apparatus (e.g., an external optical disc drive), for peak power/current reduction, and related electronic device and machine-readable medium are proposed to solve the above-mentioned problems.

According to a first aspect of the present invention, an exemplary method of controlling an electronic device is disclosed. The electronic device has a plurality of mechanical mechanisms including at least a first mechanical mechanism and a second mechanical mechanism. The exemplary method includes: driving the first mechanical mechanism by applying a first control signal to the first mechanical mechanism; driving the second mechanical mechanism by applying a second control signal to the second mechanical mechanism; comparing the first control signal with a first predetermined threshold, and accordingly generating a first comparison result; and selectively adjusting the second control signal according to at least the first comparison result.

According to a second aspect of the present invention, an exemplary electronic device is disclosed. The exemplary electronic device includes a plurality of mechanical mechanisms, including at least a first mechanical mechanism and a second mechanical mechanism; and a control module, electrically connected to at least the first mechanical mechanism and the second mechanical mechanism. The control module includes a first controller, a second controller, and an output controller. The first controller is arranged for driving the first mechanical mechanism by applying a first control signal to the first mechanical mechanism. The second controller is arranged for driving the second mechanical mechanism by applying a second control signal to the second mechanical mechanism. The output controller includes a first comparing unit and an adjusting unit. The first comparing unit is arranged for comparing the first control signal with a first predetermined threshold, and accordingly generating a first comparison result. The adjusting unit is arranged for selectively adjusting the second control signal according to at least the first comparison result.

According to a third aspect of the present invention, an exemplary non-transitory machine-readable medium is disclosed. The exemplary non-transitory machine-readable medium stores a program code. When the program code is executed by a processor, the processor performs following steps: driving a first mechanical mechanism of an electronic device by applying a first control signal to the first mechanical mechanism; driving a second mechanical mechanism of the electronic device by applying a second control signal to the second mechanical mechanism; comparing the first control signal with a predetermined threshold, and accordingly generating a comparison result; and selectively adjusting the second control signal according to at least the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an optical storage apparatus according to an exemplary embodiment of the present invention.

FIG. 2 is a diagram illustrating the relation among control signals of the spindle motor and sled motor and the overall current consumed by the optical storage apparatus.

FIG. 3 is a flowchart illustrating an exemplary method of controlling the optical storage apparatus under a first operational scenario.

FIG. 4 is a block diagram illustrating an exemplary implementation of the spindle motor controller shown in FIG. 1.

FIG. 5 is a flowchart illustrating an exemplary method of controlling the optical storage apparatus under a second operational scenario.

FIG. 6 is a flowchart illustrating an exemplary method of controlling the optical storage apparatus under a third operational scenario.

FIG. 7 is a flowchart illustrating an exemplary method of controlling the optical storage apparatus under a fourth operational scenario.

FIG. 8 is a diagram illustrating the relationship between the data transfer rate and the track position.

FIG. 9 is a diagram illustrating the relationship between the rotational speed and the track position.

FIG. 10 is a flowchart illustrating an exemplary method of controlling the optical storage apparatus under a fifth operational scenario.

FIG. 11 is a diagram illustrating an optical storage apparatus according to another exemplary embodiment of the present invention.

FIG. 12 is a diagram illustrating an alternative design of the control module shown in FIG. 1.

FIG. 13 is a diagram illustrating a first exemplary implementation of the output controller shown in FIG. 12 according to the present invention.

FIG. 14 is a flowchart illustrating an exemplary method of controlling the optical storage apparatus by monitoring the signal level of the servo control signal.

FIG. 15 is a diagram illustrating a second exemplary implementation of the output controller shown in FIG. 12 according to the present invention.

FIG. 16 is a flowchart illustrating another exemplary method of controlling the optical storage apparatus by monitoring the signal level of the servo control signal.

FIG. 17 is a diagram illustrating a firmware-based implementation of the control module shown in FIG. 12 according to an exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “electrically connected” is intended to mean either an indirect or direct electrical connection. Accordingly, if one device is electrically connected to another device, that connection may be through a direct electrical connection, or through an indirect electrical connection via other devices and connections.

The conception of the present invention is to properly control the mechanical mechanisms to prevent the peak power/current consumption from exceeding a permitted level when more than one active mechanical mechanism of an optical storage apparatus is involved in accomplishing a particular task. By way of example, but not limitation, the optical storage apparatus may reduce the peak power/current at the expense of the performance of the optical storage apparatus. However, in most cases, the performance degradation of the optical storage apparatus is not perceivable to users. Technical features of the present invention are detailed as follows.

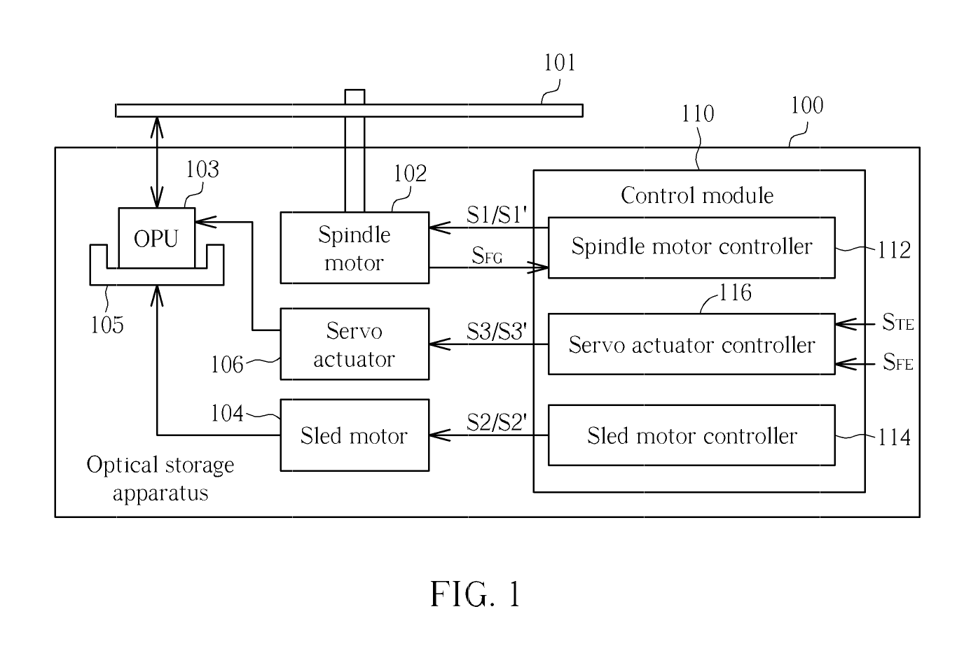

FIG. 1 is a diagram illustrating an optical storage apparatus according to an exemplary embodiment of the present invention. The exemplary optical storage apparatus 100 includes, but is not limited to, a plurality of mechanical mechanisms (e.g., a spindle motor 102, a sled motor 104, and a servo actuator 106) and a control module 110 having a plurality of controllers (e.g., a spindle motor controller 112, a sled motor controller 114, and a servo actuator controller 116. The spindle motor 102 is electrically connected to the spindle motor controller 112, and controlled by the spindle motor controller 112 for rotating an optical storage medium (e.g., an optical disc) 101 at a desired rotational speed. The sled motor 104 is electrically connected to the sled motor controller 114, and controlled by the sled motor controller 114 for moving a sled 105 on which an optical pick-up unit (OPU) 103 is disposed in a radial direction of the optical storage medium 101. The servo actuator 106 is electrically connected to the servo actuator controller 116, and controlled by the servo actuator controller 116 for moving an objective lens of the OPU 103 to thereby make a laser spot focused on a desired recording layer of the optical storage medium 101 and/or locked to a desired track on the desired recording layer.

As a person skilled in the pertinent art can readily understand operations and functions of the spindle motor 102, the sled motor 104, and the servo actuator 106, further description is omitted here for brevity. It should be noted that only the components pertinent to the present invention are shown in FIG. 1. That is, the exemplary optical storage apparatus 100 may contain additional elements for other functions. For example, the optical storage apparatus 100 may also include a signal synthesizing circuit (not shown) employed for generating a tracking error signal S_{TE} and a focus error signal S_{FE} according to signals reflected from the optical storage medium 101, and a decoding circuit (not shown) employed for deriving information from a radio frequency (RF) signal obtained from reading the optical storage medium 101.

In this exemplary embodiment, the optical storage apparatus 100 may be an external optical disc drive which draws the needed supply power from a computer host to which the external optical disc drive is connected. Thus, the current/power consumption of the optical storage apparatus 100 should be well controlled to avoid violating the power supply capability of the interface (e.g., a universal serial bus (USB)) between the external optical disc drive and the computer host.

For example, one USB port is allowed to supply a current with 0.5 A at most. The present invention therefore proposes a method of controlling the optical storage apparatus 100 for peak power/current reduction, and may be briefly summarized by following steps: driving a first mechanical mechanism (e.g., one of the spindle motor 102, the sled motor 104, and the servo actuator 106) by applying a first control signal (e.g., one of the control signals S1, S2, and S3) to the first mechanical mechanism, wherein a second mechanical mechanism (e.g., another of the spindle motor 102, the sled motor 104, and the servo actuator 106) is inactive while the first mechanical mechanism is operating in response to the first control signal; adjusting the first control signal applied to the first mechanical mechanism when the second mechanical mechanism is requested to be active; and driving the second mechanical mechanism by applying a second control signal (e.g., another of the control signals S1, S2, and S3) to the second mechanical mechanism while the first mechanical mechanism is operating in response to the adjusted first control signal (e.g., one of the adjusted control signal S1′, S2′, and S3′).

In one exemplary implementation, adjusting the first control signal applied to the first mechanical mechanism is accomplished by reducing the first control signal and accordingly generating the adjusted first control signal to the first mechanical mechanism. In another exemplary implementation, adjusting the first control signal applied to the first mechanical mechanism is accomplished by setting the adjusted first control through stopping the first control signal from being applied to the first mechanical mechanism. For example, the adjusted first control signal is kept at a predetermined voltage level or control level (e.g., “0”), thereby having no control over the first mechanical mechanism. Since the adjusted first control signal is smaller than the original first control signal, the current/power consumption of the first mechanical mechanism operating in response to the adjusted first control signal can be effectively reduced. Though the second mechanical mechanism becomes active while the first mechanical mechanism is operating in response to the adjusted first control signal, the overall current/power consumption of the first mechanical mechanism and the second mechanical mechanism is not beyond the acceptable level. Several operational scenarios of the optical storage apparatus 100 are discussed as below.

Regarding a first operational scenario, the above-mentioned first mechanical mechanism is the spindle motor 102, and the above-mentioned second mechanical mechanism is the sled motor 104. When the spindle motor 102 accelerates/decelerates its spindle rotation, the spindle motor 102 will consume much current. Similarly, when the sled motor 104 is moving the sled 105, the sled motor 104 will consume much current. If both of the spindle motor 102 and the sled motor 104 are active at the same time, the peak current/power consumption may be too high. To solve this problem, the control signal S1 which drives the spindle motor 102 to accelerate/decelerate its spindle rotation would be adjusted by the spindle motor controller 112 when the sled motor 104 is requested to be active for moving the sled 105. Please note that the adjusted control signal S1′ may be set by reducing the control signal S1 applied to the spindle motor 102 such that the spindle motor 102 makes its spindle rotate with slower acceleration/deceleration, or may be set by stopping the control signal S1 from being applied to the spindle motor 102 such that the adjusted control signal S1′ has no control over the spindle motor 102.

It should be noted that the three controllers (spindle motor controller 112, servo actuator controller 116, and sled motor controller 114) can be combined in a single controller in some embodiments (not shown), and the corresponding control signals still respectively control each one of the spindle motor 102, servo actuator 106, and sled motor 104.

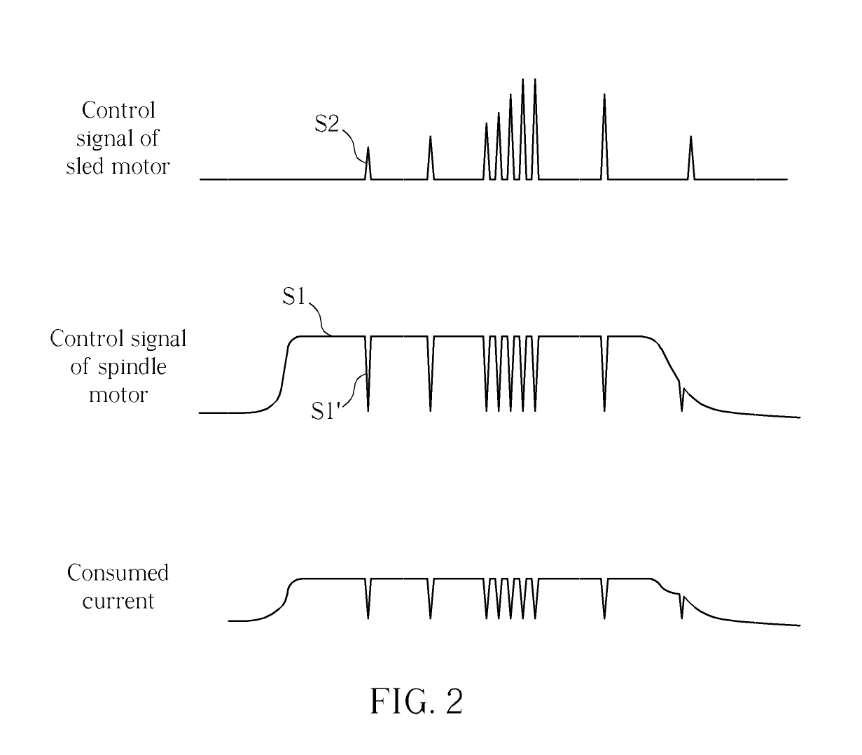

Please refer to FIG. 2, which is a diagram illustrating the relation among control signals of the spindle motor 102 and sled motor 104 and the overall current consumed by the optical storage apparatus 100. As can be seen from FIG. 2, the control signal S1 which drives the spindle motor 102 to accelerate/decelerate its spindle rotation is reduced/stopped each time the control signal S2 enables the sled motor 104. Thus, the current consumption is reduced each time the control signal S2 enables the sled motor 104. Though the spindle acceleration/deceleration time may be slightly prolonged due to the adjustment made to the control signal S1, it is ensured that the peak current/power consumption does not exceed the acceptable level.

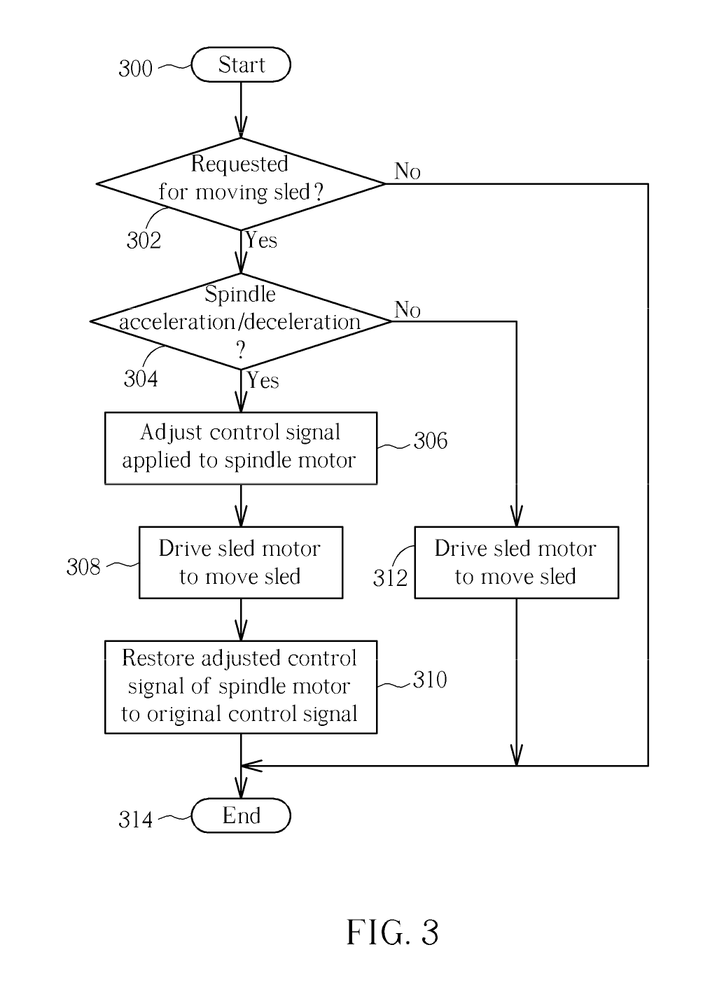

FIG. 3 is a flowchart illustrating an exemplary method of controlling the optical storage apparatus 100 under the first operational scenario. Provided that the result is substantially the same, the steps are not required to be executed in the exact order shown in FIG. 3. The exemplary method includes the following steps.

Step 300: Start.

Step 302: Check if the sled motor 104 is requested for moving the sled 105. If yes, go to step 304; otherwise, go to step 314.

Step 304: Check if the spindle motor 102 is accelerating/decelerating its spindle rotation. If yes, go to step 306; otherwise, go to step 312.

Step 306: Adjust the control signal S1 applied to the spindle motor 102.

Step 308: Drive the sled motor 104 to move the sled 105 by applying a control signal S2 to the sled motor 104.

Step 310: Restore the adjusted control signal S1′ to the original control signal S1. Go to step 314.

Step 312: Drive the sled motor 104 to move the sled 105 by applying a control signal S2 to the sled motor 104.

Step 314: End.

In step 304, a frequency generator (FG) signal S_{FG} generated from the spindle motor 102 may be used to monitor the rotational speed of the spindle. More specifically, the frequency of the FG signal S_{FG} is proportional to the rotational speed of the spindle. Thus, when the frequency error (frequency variation) of the FG signal S_{FG} is found greater than a predetermined threshold value, it is determined that the spindle motor 102 is accelerating/decelerating its spindle rotation.

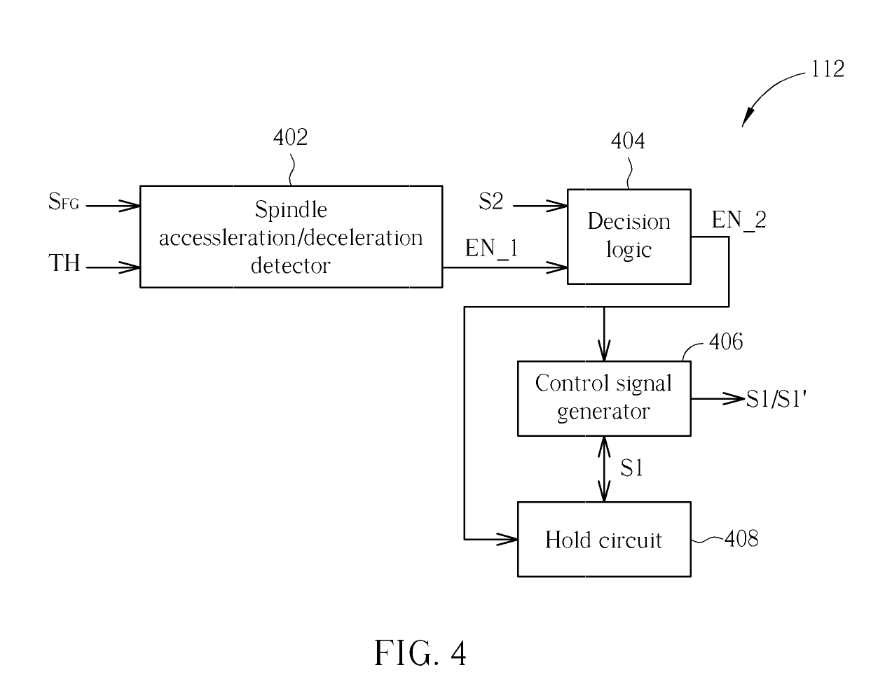

Please refer to FIG. 4, which is a block diagram illustrating an exemplary implementation of the spindle motor controller 112 shown in FIG. 1. The spindle motor controller 112 includes a spindle acceleration/deceleration detector 402, a decision logic 404, a control signal generator 406, and a hold circuit 408. The spindle acceleration/deceleration detector 402 estimates the frequency error (frequency variation) of the FG signal S_{FG}, and generates an indication signal EN_1 with a specific voltage level or control level only when the frequency error (frequency variation) of the FG signal S_{FG} is found greater than the predetermined threshold value TH. The decision logic 404 generates an indication signal EN_2 with a specific voltage level or control level only when receiving the indication signal EN_1 indicative of the spindle acceleration/deceleration and the control signal S2 indicative of the activation of the sled motor 104 (steps 302 and 304). When the decision logic 404 outputs the indication signal EN_2 to inform the event of concurrent spindle acceleration/deceleration and sled movement, the control signal generator 406 adjusts the control signal S1 to make the spindle motor 102 operate in response to the adjusted control signal S1′, and the hold circuit 408 holds the control signal S1 (Step 306). Next, after the sled 105 is successfully moved by the sled motor 104, the control signal generator 406 restores the adjusted control signal S1′ to the control signal S1 held by the hold circuit 408 (step 310). It should be noted that, when the decision logic 404 does not receive the control signal S2 indicating that the sled motor 104 is requested to be active or the indication signal EN_1 indicating that the spindle motor 102 is accelerating/decelerating its spindle rotation, the control signal generator 406 keeps outputting the control signal S1 (step 302/304).

Regarding a second operational scenario, the above-mentioned first mechanical mechanism is the spindle motor 102/sled motor 104, and the above-mentioned second mechanical mechanism is the servo actuator 106. Before a track-on process is performed, a track-seeking process may be performed to move the OPU 103 from a current track to a target track. Thus, the spindle motor 102 and the sled motor 104 may be involved in seeking the target track on the optical storage medium 101. If the spindle motor 102/sled motor 104 and the servo actuator 106 are all active at the same time when the track-on process is enabled for locking the laser spot to the target track, the peak current/power consumption may be too high. To solve this problem, when the servo actuator controller 116 is requested to be active during a track-on process for moving the objective lens of the OPU 103 in response to the servo control signal (e.g., the tracking error signal S_{TE} and/or the focus error signal S_{FE}), the control signal S1 which drives the spindle motor 102 to accelerate/decelerate its spindle rotation would be adjusted by the spindle motor controller 112 and/or the control signal S2 which drives the sled motor 104 to move the sled 105 would be adjusted by the sled motor controller 114. Please note that the adjusted control signal S1′ may be set by reducing the control signal S1 applied to the spindle motor 102 such that the spindle motor 102 makes its spindle rotate with slower acceleration/deceleration, or me by set by stopping the control signal S1 from being applied to the spindle motor 102 such that the adjusted control signal S1′ has no control over the spindle motor 102. Regarding the adjusted control signal S2′, it may be set by stopping the control signal S2 from being applied to the sled motor 104 such that the adjusted control signal S2′ has no control over the sled motor 104.

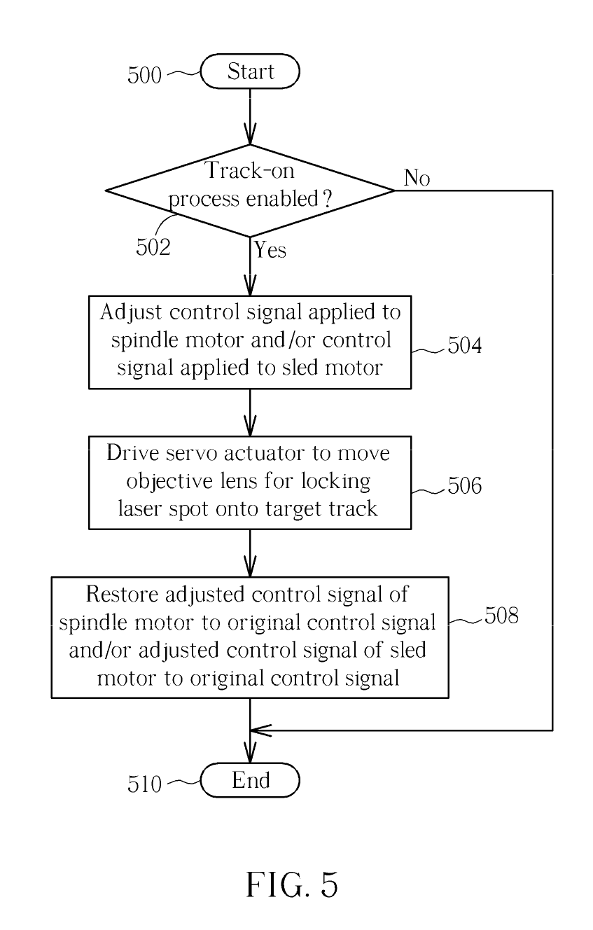

FIG. 5 is a flowchart illustrating an exemplary method of controlling the optical storage apparatus 100 under the second operational scenario. Provided that the result is substantially the same, the steps are not required to be executed in the exact order shown in FIG. 5. The exemplary method includes the following steps.

Step 500: Start.

Step 502: Check if a track-on process is enabled? If yes, go to step 504; otherwise, go to step 510.

Step 504: Adjust the control signal S1 applied to the spindle motor 102 and/or the control signal S2 applied to the sled motor 104.

Step 506: Drive the servo actuator 106 to move the objective lens of the OPU 103 by applying a control signal S3 to the servo actuator 106, thereby locking the laser spot to the target track.

Step 508: Restore the adjusted control signal S1′ to the original control signal S1 and/or the adjusted control signal S2′ to the original control signal S2.

Step 510: End.

It should be noted that the spindle motor controller 112/sled motor controller 114 may has a hold circuit (e.g., the hold circuit 408 shown in FIG. 4) for holding the original control signal when the track-on process is enabled (step 504), and then restores the adjusted control signal to the original control signal after the servo actuator controller 116 completes driving the servo actuator 106 to move the objective lens of the OPU 103 (step 508).

Regarding a third operational scenario, the above-mentioned first mechanical mechanism is the spindle motor 102/servo actuator 106, and the above-mentioned second mechanical mechanism is the sled motor 104. After the laser spot is locked onto the target track of the target recording layer, a track-following process is enabled to control the OPU 103 to thereby make the laser spot move along the spiral track for data reading/recording. Thus, the spindle motor 102 and the servo actuator 106 may be both involved in moving the laser spot along the spiral track. If the sled motor 104 is requested to move the sled 105 during the track-following process, the spindle motor 102/sled motor 104 and the servo actuator 106 are all active at the same time, resulting in high current/power consumption which may exceed the acceptable level. To solve this problem, when the sled motor 104 is requested to be active during a track-following process for moving the sled 105 in response to the control signal S2, the control signal S1 which drives the spindle motor 102 to accelerate/decelerate its spindle rotation would be adjusted by the spindle motor controller 112 and/or the control signal S3 which drives the servo actuator 106 to move the objective lens in the OPU 103 would be adjusted by the servo actuator controller 116. Please note that the adjusted control signal S1′ may be set by reducing the control signal S1 applied to the spindle motor 102 or stopping the control signal S1 from being applied to the spindle motor 102. Regarding the adjusted control signal S3′, it may be set by lowering an output gain applied to the servo control signal, including the tracking error signal S_{TE} and/or the focus error signal S_{FE}.

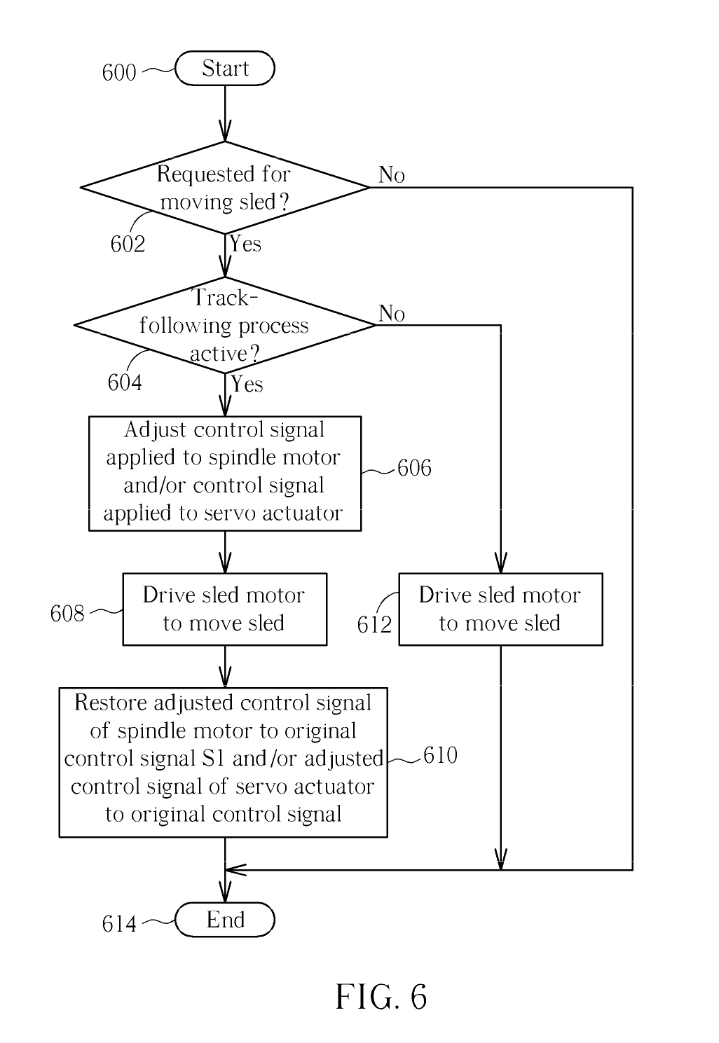

FIG. 6 is a flowchart illustrating an exemplary method of controlling the optical storage apparatus 100 under the third operational scenario. Provided that the result is substantially the same, the steps are not required to be executed in the exact order shown in FIG. 6. The exemplary method includes following steps.

Step 600: Start.

Step 602: Check if the sled motor 104 is requested for moving the sled 105. If yes, go to step 604; otherwise, go to step 614.

Step 604: Check if the track-following process is active now. If yes, go to step 606; otherwise, go to step 612.

Step 606: Adjust the control signal S1 applied to the spindle motor 102 and/or the control signal S3 applied to the servo actuator 106.

Step 608: Drive the sled motor 104 to move the sled 105 by applying a control signal S2 to the sled motor 104.

Step 610: Restore the adjusted control signal S1′ to the original control signal S1 and/or the adjusted control signal S3′ to the original control signal S3. Go to step 614.

Step 612: Drive the sled motor 104 to move the sled 105 by applying a control signal S2 to the sled motor 104.

Step 614: End.

It should be noted that the spindle motor controller 112/servo actuator controller 116 may has a hold circuit (e.g., the hold circuit 408 shown in FIG. 4) for holding the original control signal (step 606), and then restores the adjusted control signal to the original control signal after the sled motor controller 114 completes driving the sled motor 104 to move the sled 105 (step 610).

Regarding a fourth operational scenario, the above-mentioned first mechanical mechanism is the sled motor 104, and the above-mentioned second mechanical mechanism is the spindle motor 102 arranged to operate under a constant linear velocity (CLV) mode, such as a zoned-CLV (Z-CLV) mode. When a track-seeking process is performed for making the OPU 103 jump to a target track, the spindle motor 102 may be required to change its rotational speed and/or the sled motor 104 may be required to move the sled 105, depending upon the distance between the current track and the target track. If the spindle motor 102 and the sled motor 104 are both active at the same time during the track-seeking process, the current/power consumption may be too high. To solve this problem, the sled motor 104 is enabled for moving the sled 105 for carrying the OPU 103 to the target track before the spindle motor 102 changes the rotational speed of the optical storage medium 101 by accelerating/decelerating its spindle rotation. In other words, when the spindle motor 102 is required to change the rotational speed of the optical storage medium 101 in response to the control signal S1, the control signal S2 which drives the sled motor 104 would be adjusted by the sled motor controller 114. For example, after the OPU 103 is moved to the target track, the sled motor controller 114 adjusts the control signal S2 by stopping the control signal S2 from being applied to the sled motor 104 such that the adjusted control signal S2′ has no control over the sled motor 104.

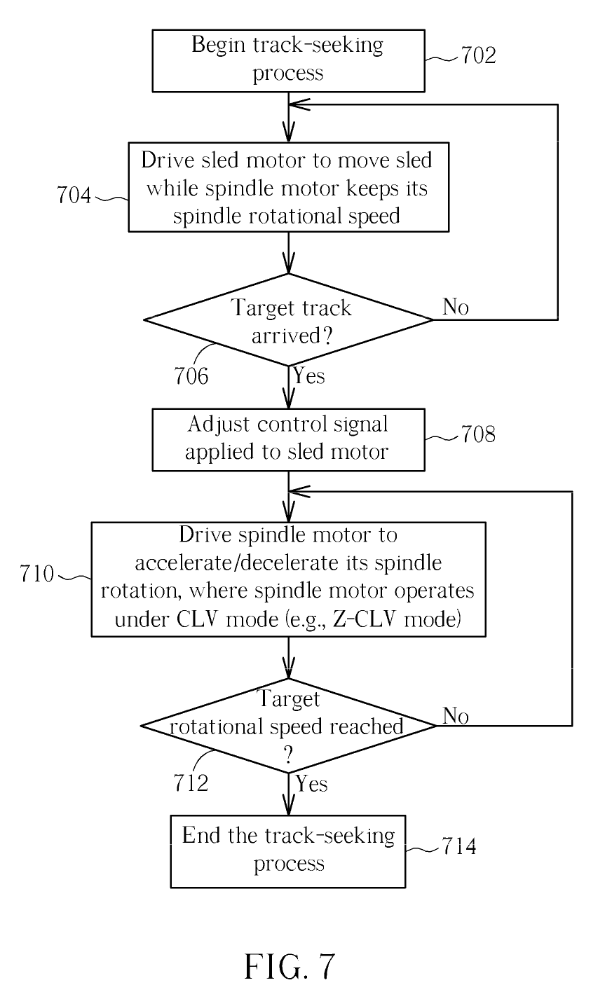

FIG. 7 is a flowchart illustrating an exemplary method of controlling the optical storage apparatus 100 under the fourth operational scenario. Provided that the result is substantially the same, the steps are not required to be executed in the exact order shown in FIG. 7. The exemplary method includes following steps.

Step 702: Begin a track-seeking process.

Step 704: Drive the sled motor 104 to move the sled 105 by applying a control signal S2 to the sled motor 104 while the spindle motor 102 keeps its spindle rotational speed.

Step 706: Check if the sled 105/OPU 103 has arrived at the target track. If yes, go to step 708; otherwise, go to step 704 to keep moving the sled 105 for seeking the target track.

Step 708: Adjust the control signal S2 applied to the sled motor 104. For example, as the sled motor controller 114 stops the control signal S2 from being applied to the sled motor 104, the resultant adjusted control signal S2′ is kept at a predetermined voltage level or control level (e.g., “0”) and thus has no control over the sled motor 104.

Step 710: Drive the spindle motor 102 to accelerate/decelerate its spindle rotation (i.e., to change the rotational speed of the optical storage medium 101) by applying a control signal S1 to the spindle motor 102 which operates under the CLV mode.

Step 712: Check if the rotational speed has reached the target speed. If yes, go to step 714; otherwise, go to step 710 to keep changing the rotational speed of the optical storage medium 101.

Step 714: End the track-seeking process.

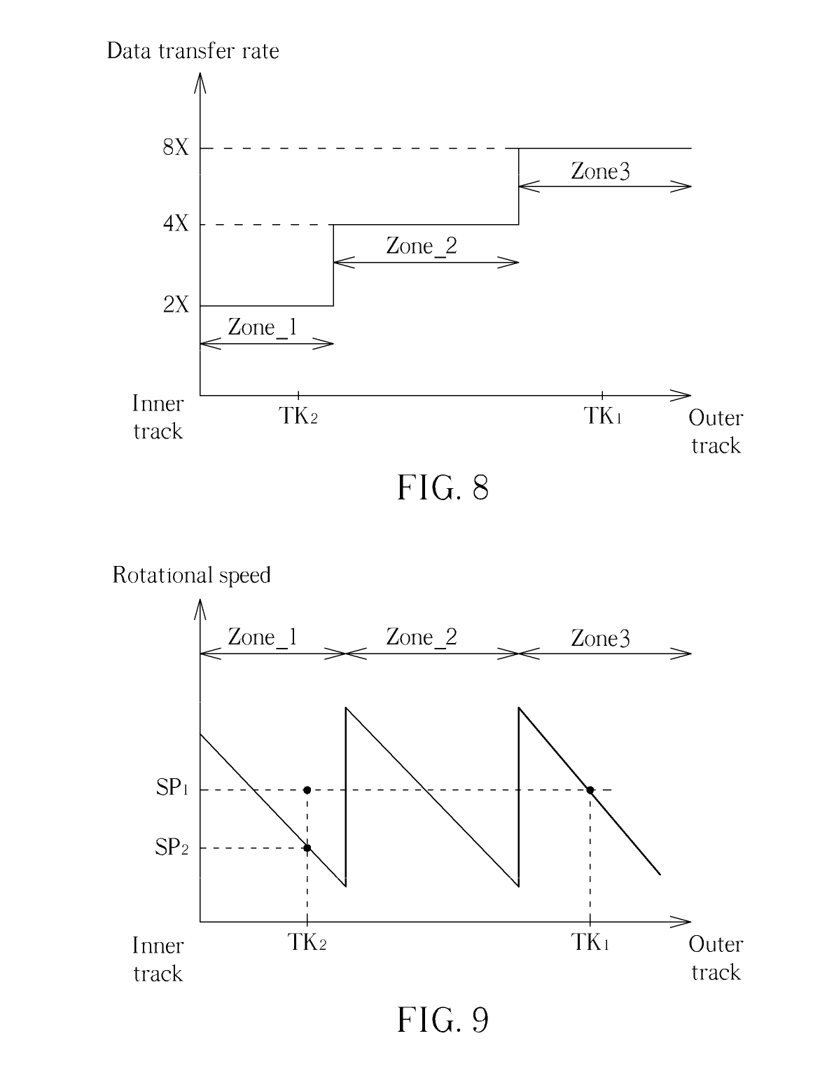

Please refer to FIG. 7 in conjunction with FIG. 8 and FIG. 9. FIG. 8 is a diagram illustrating the relationship between the data transfer rate and the track position. FIG. 9 is a diagram illustrating the relationship between the rotational speed and the track position. Suppose that the spindle motor 102 is arranged to operate under a Z-CLV mode. Therefore, the optical storage medium 101, such as an optical disc, is divided into a plurality of ring-shaped zones. As shown in FIG. 8, the inner zone Zone_1 is accessed using a lower data transfer rate (i.e., 2×), the outer zone Zone_3 is accessed using a higher data transfer rate (i.e., 8×), and the middle zone Zone_2 is accessed using a medium data transfer rate (i.e., 4×). Suppose that the OPU 103 is currently located at the track TK₁ within the outer zone Zone_3, and the next track TK₂ to be accessed is located in the inner zone Zone_1. Thus, a track-seeking process should be enabled to seek the target track TK₂ (step 702). As there is a long distance from the current track TK₁ to the target track TK₂, the sled motor controller 114 therefore generates the control signal S2 to the sled motor 104 for moving the sled 105 on which the OPU 103 is disposed from the current track TK₁ to the target track TK₂ (steps 706 and 704). It should be noted that the rotational speed of the optical storage medium 101 is not changed while the sled motor 104 is moving the sled 105. That is, in this embodiment, the spindle motor 102 does not accelerate/decelerate its spindle rotational during the moving of the sled 105.

Therefore, as shown in FIG. 9, the rotational speed is maintained at SP₁ when the sled motor 104 is moving the sled 105. After the sled 105/OPU 103 has arrived at the target track TK₂, the sled motor 104 stops moving the sled 105 and the spindle motor 102 is driven by the spindle motor controller 112 to start accelerating/decelerating its spindle rotation for changing the rotational speed to the target speed SP₂ (steps 708, 710, and 712).

Regarding a fifth operational scenario, the above-mentioned first mechanical mechanism is the spindle motor 102 which is arranged to operate under a constant angular velocity (CAV) mode, and the above-mentioned second mechanical mechanism is the sled motor 104. When a track-seeking process is performed for making the OPU 103 jump to a target track, the sled motor 104 may be required to move the sled 105. If the sled motor 104 is enabled to move the sled 105 while the spindle motor 102 is operating for rotating the optical storage medium 101 at a desired constant angular velocity under the CAV mode, the current/power consumption may be too high. To solve this problem, the control signal S1 which drives the spindle motor 102 to maintain its spindle rotation at the desired constant angular velocity would be adjusted by the spindle motor controller 112 when the sled motor 104 is requested to be active for moving the sled 105. Please note that the adjusted control signal S1′ may be set by reducing the control signal S1 applied to the spindle motor 102 such that the spindle motor 102 makes its spindle rotate with slower acceleration/deceleration, or may be set by stopping the control signal S1 from being applied to the spindle motor 102 such that the adjusted control signal S1′ has no control over the spindle motor 102. Next, after the sled 105 is successfully moved by the sled motor 104, the spindle motor controller 112 restores the adjusted control signal S1′ to the original control signal S1.

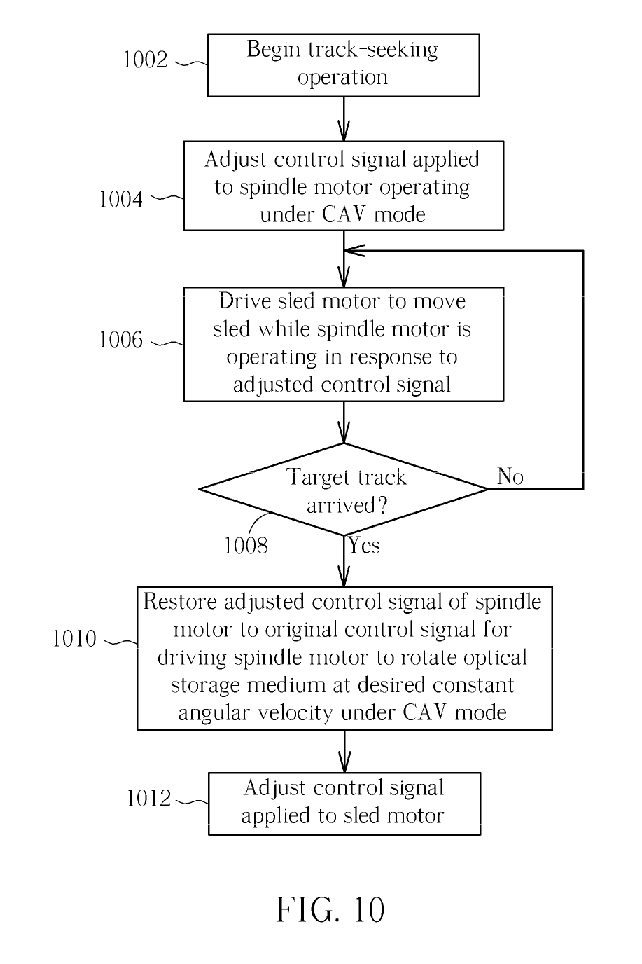

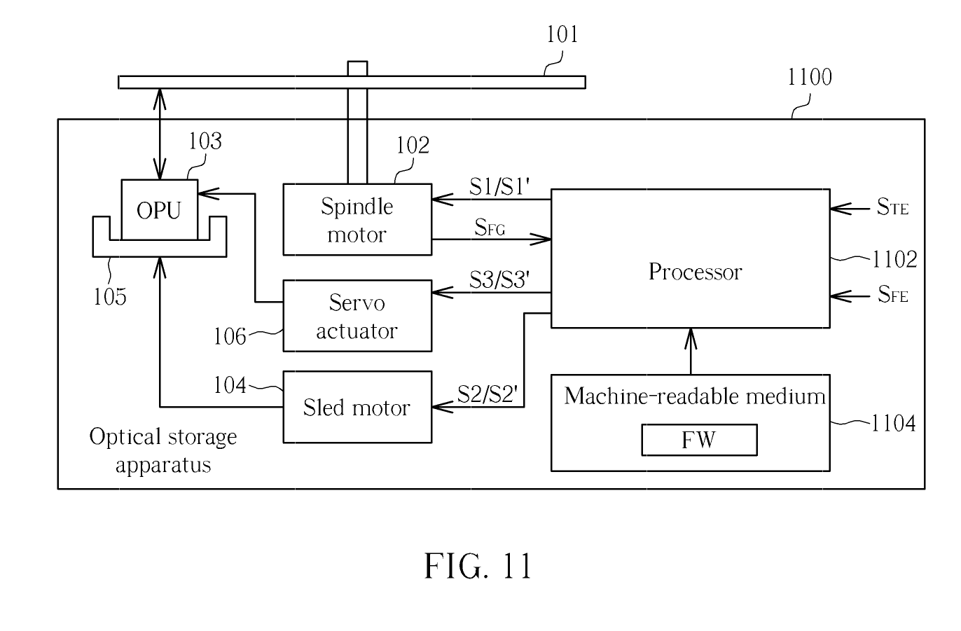

FIG. 10 is a flowchart illustrating an exemplary method of controlling the optical storage apparatus 100 under the fifth operational scenario. Provided that the result is substantially the same, the steps are not required to be executed in the exact order shown in FIG. 10. The exemplary method includes following steps.

Step 1002: Begin a track-seeking process.

Step 1004: Adjust the control signal S1 applied to the spindle motor 102 operating under the CAV mode.

Step 1006: Drive the sled motor 104 to move the sled 105 by applying a control signal S2 to the sled motor 104 while the spindle motor 102 is operating in response to the adjusted control signal S1′.

Step 1008: Check if the sled 105/OPU 103 has arrived at the target track. If yes, go to step 1010; otherwise, go to step 1006 to keep moving the sled 105 for seeking the target track.

Step 1010: Restore the adjusted control signal S1′ to the original control signal S1 for driving the spindle motor 102 to rotate the optical storage medium 101 at the desired constant angular velocity under the CAV mode.

Step 1012: End the track-seeking process.

It should be noted that the spindle motor controller 112 may has a hold circuit (e.g., the hold circuit 408 shown in FIG. 4) for holding the original control signal (step 1004), and then restores the adjusted control signal to the original control signal after the sled motor controller 114 completes driving the sled motor 104 to move the sled 105 to the target track (step 1010).

Regarding the exemplary embodiment shown in FIG. 1, the spindle motor controller 112, the servo actuator controller 116, and the sled motor controller 114 may be implemented by pure hardware. That is, the adjustments made to the control signals S1, S2, and S3 are controlled by hardware elements. However, in an alternative design, the adjustments made to the control signals S1, S2, and S3 may be controlled by a processor executing a program code. Please refer to FIG. 11, which is a diagram illustrating an optical storage apparatus according to another exemplary embodiment of the present invention. The exemplary optical storage apparatus 1100 includes, but is not limited to, a plurality of mechanical mechanisms (e.g., the aforementioned spindle motor 102, sled motor 104, and servo actuator 106), a processor 1102, and a non-transitory machine-readable medium 1104 having a program code (e.g., firmware FW of the optical storage apparatus 1100) stored therein. By way of example, but not limitation, the machine-readable medium 1104 may be a non-volatile storage device such as a flash memory. When loaded and executed by the processor 1102, the firmware FW causes the processor 1102 to properly adjust the control signal S1/S2/S3, thereby preventing the overall current/power consumption of the optical storage apparatus 1100 from exceeding the acceptable level.

Specifically, the firmware FW executed by the processor 1102 functions as the control module 110 shown in FIG. 1. Thus, the program code (e.g., firmware FW of the optical storage apparatus 1100), when executed by the processor 1102, would cause the processor 1102 to perform following steps for peak power/current reduction: driving a first mechanical mechanism (e.g., one of the spindle motor 102, the sled motor 104, and the servo actuator 106) by applying a first control signal (e.g., one of the control signals S1, S2, and S3) to the first mechanical mechanism, wherein a second mechanical mechanism (e.g., another of the spindle motor 102, the sled motor 104, and the servo actuator 106) is inactive while the first mechanical mechanism is operating in response to the first control signal; adjusting the first control signal applied to the first mechanical mechanism when the second mechanical mechanism is requested to be active; and driving the second mechanical mechanism by applying a second control signal (e.g., another of the control signals S1, S2, and S3) to the second mechanical mechanism while the first mechanical mechanism is operating in response to the adjusted first control signal (e.g., one of the adjusted control signal S1′, S2′, and S3′).

In this firmware-based implementation, adjusting the first control signal applied to the first mechanical mechanism is accomplished by setting the adjusted first control through stopping the first control signal from being applied to the first mechanical mechanism. As a person skilled in the art can readily understand the operation of the program code (e.g., firmware FW of the optical storage apparatus 1100) executed by the processor 1102 after reading above paragraphs directed to different operational scenarios of the exemplary optical storage apparatus 100 shown in FIG. 1, further description is omitted here for brevity.

It should be noted that the aforementioned mechanical mechanisms, such as the spindle motor 102, the sled motor 104, and the servo actuator 106 shown in FIG. 1 and FIG. 11, are for illustrative purposes only. Any optical storage apparatus employing the proposed method to control mechanical mechanisms included therein for peak power/current reduction obeys the spirit of the present invention and falls within the scope of the present invention.

If the optical storage medium (e.g., an optical disc) 101 has defects caused by dirt and/or scratch, the servo actuator controller 116 would increase the control signal S3 for driving the servo actuator 106 to stabilize the tracking servo control and/or the focus servo control, which resulting in increased power/current consumption inevitably. When the sled motor 104 is increasing the moving speed of the sled 105 or the spindle motor 102 is increasing the rotational speed of the spindle at the same time, the peak power/current consumption may exceed the maximum level that the power source of the optical storage apparatus (e.g., an external optical disc drive) 100 can afford. The present invention also provides solutions to this problem.

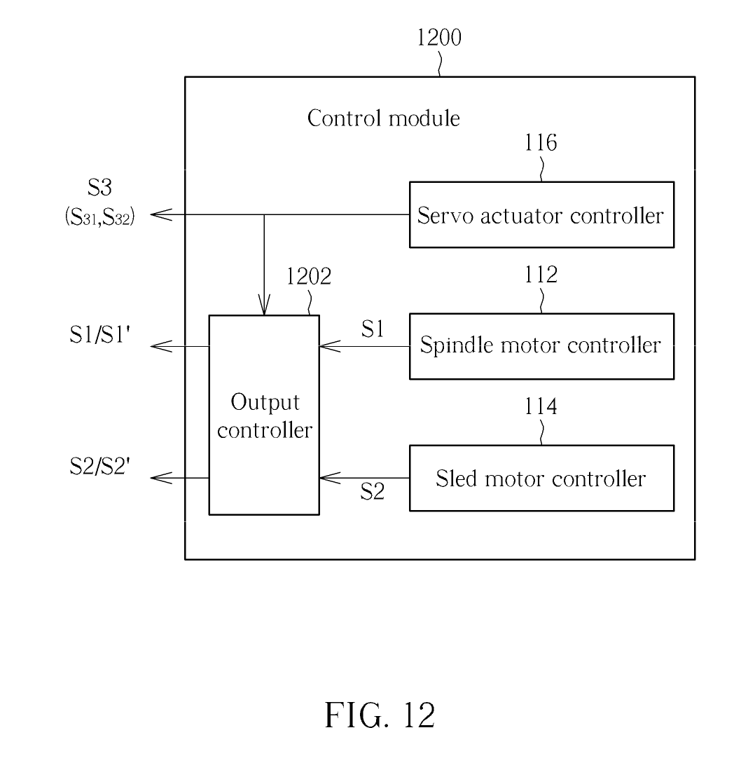

Please refer to FIG. 1 in conjunction with FIG. 12. FIG. 12 is a diagram illustrating an alternative design of the control module 110 shown in FIG. 1. The control module 110 may be realized by the control module 1200, which includes a plurality of controllers (e.g., the aforementioned spindle motor controller 112, the sled motor controller 114, and the servo actuator controller 116) and an output controller 1202. As mentioned above, the spindle motor controller 112 is arranged to generate the control signal S1 for driving the spindle motor 102 shown in FIG. 1, the sled motor controller 114 is arranged to generate the control signal S2 for driving the sled motor 104 shown in FIG. 1, and the servo actuator controller 116 is arranged to generate the control signal S3 for driving the servo actuator 106. It should be noted that the servo actuator 106 may include a focus actuator for applying focus control to the OPU 103, and a tracking actuator for applying tracking control to the OPU 103. Hence, in this embodiment, the control signal S3 may include a focus control output S₃₁ used for driving the focus actuator which is one part of the servo actuator 106, and a tracking control output S₃₂ used for driving the tracking actuator which is another part of the servo actuator 106.

The output controller 1202 is arranged to check the control signal S3 for selectively adjusting the control signal S1/S2. Specifically, the output controller 1202 compares the control signal S3, either the focus control output S₃₁ or the tracking control output S₃₂, with a predetermined threshold, and refers to the comparison result to decide whether the control signal S1/S2 should be adjusted to generate the adjusted control signal S1′/S2′. For example, when the OPU 103 is reading data from or writing data onto a defect area of the optical storage medium (e.g., an optical disc) 101, the control signal S3 may have a large signal level instantly. Hence, with a proper setting of the predetermined threshold, the occurrence of the large current/power consumption of the servo actuator 106 can be detected. Upon detecting that the control signal S3 exceeds the predetermined threshold, the output controller 1202 adjusts the control signal S1/S2 for preventing the peak current/power consumption of the optical storage apparatus 100 from exceeding a maximum level as defined by the pertinent specification. Further details are described as below.

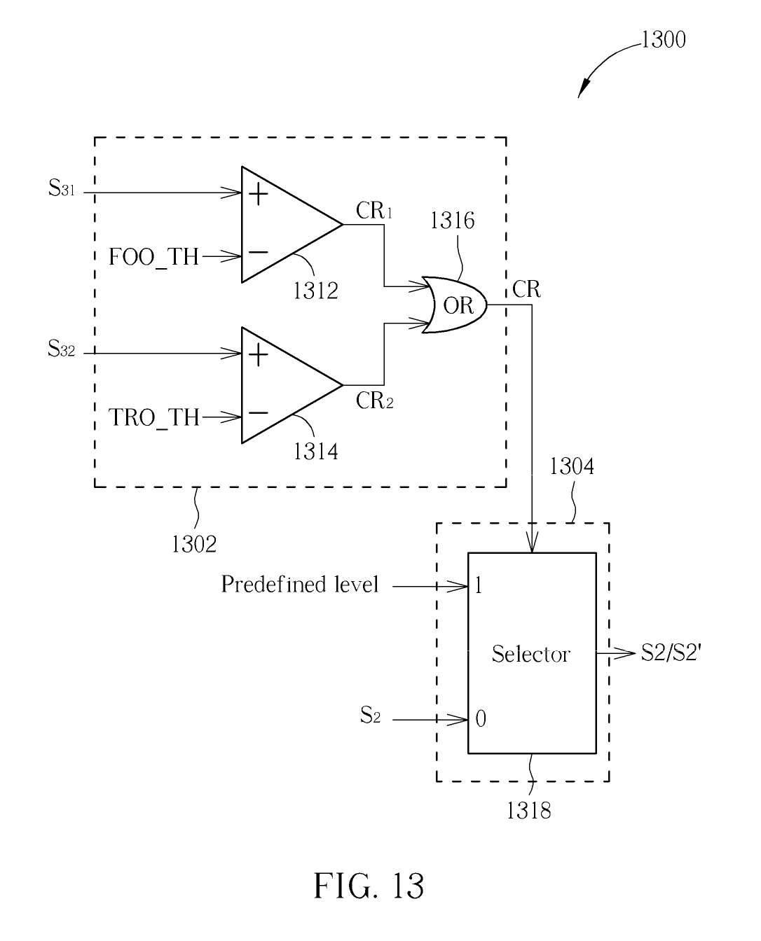

FIG. 13 is a diagram illustrating a first exemplary implementation of the output controller 1202 shown in FIG. 12 according to the present invention. The output controller 1202 shown in FIG. 12 may be realized by the hardware-based output controller 1300. As shown in FIG. 13, the output controller 1300 includes a comparing unit 1302 and an adjusting unit 1304. The comparing unit 1302 includes a plurality of comparators 1312, 1314 and a logic gate (e.g., an OR gate) 1316. The comparator 1312 is arranged to compare the focus control output S₃₁ of the control signal S3 with a predetermined threshold FOO_TH, and accordingly generate a comparison result CR₁. Specifically, when the focus control output S₃₁ exceeds the predetermined threshold FOO_TH, the comparison result CR₁ would carry one logic value “1”, and when the focus control output S₃₁ does not exceed the predetermined threshold FOO_TH, the comparison result CR₁ would carry another logic value “0”. The comparator 1314 is arranged to compare the tracking control output S₃₂ of the control signal S3 with a predetermined threshold TRO_TH, and accordingly generate a comparison result CR₂. Specifically, when the focus control output S₃₂ exceeds the predetermined threshold TRO_TH, the comparison result CR₂ would carry one logic value “1”, and when the focus control output S₃₂ does not exceed the predetermined threshold TRO_TH, the comparison result CR₂ would carry another logic value “0”. The logic gate 1316 performs an OR operation upon the comparison results CR₁ and CR₂, and generate a comparison result CR as an output of the comparing unit 1302. Therefore, when at least one of the comparison results CR₁ and CR₂ carries the logic value “1”, the comparison result CR would have the logic value “1”. In other words, only when each of the comparison results CR₁ and CR₂ carries the logic value “0”, the comparison result CR would have the logic value “0”.

In this embodiment, the adjusting unit 1304 is simply implemented by a selector 1318. Hence, the selector 1318 outputs a predetermined level as the adjusted control signal S2′ when the comparison result CR has the logic value “1”, and directly outputs the control signal S2 originally generated from the sled motor controller 114 when the comparison result CR has the logic value “0”. Specifically, when at least one of the comparison results CR₁ and CR₂ carries the logic value “1”, implying that at least one of the focus control output S₃₁ and tracking control output S₃₂ exceeds the corresponding predetermined threshold FOO_TH/TRO_TH, the adjusting unit 1304 outputs the adjusted control signal S2′ instead of the original control signal S2. In one exemplary design, the adjusting unit 1304 may generate the adjusted control signal S2′ by holding the control signal S2 at the predefined level.

For example, the predefined level may be a signal level of the control signal S2 sampled instantly at the timing when the selector 1318 switches from the control signal S2 to the predefined level. In another exemplary design, the predefined level may be a zero value. Therefore, the adjusting unit 1304 generates the adjusted control signal S2′ by stopping the control signal S2 from being applied to the sled motor 104 such that the adjusted control signal S2 is muted and has no control over the sled motor 104. No matter which adjusting scheme is employed for generating the adjusted control signal S2′, the adjusted control signal S2′ would have a signal level not greater than that of the original control signal S2 during the time period in which the control signal S3 is found larger than the predetermined threshold. In this way, when defects are encountered by the OPU 103 during the active period of the sled motor 104, the consumed peak current/power is prevented from exceeding the maximum level that the power source of the optical storage apparatus 100 (e.g., an external optical disc drive) can afford. Besides, as no signal level reduction is made to the control signal S3 for lowering the current/power consumption of the servo actuator 106, the read/write performance of the OPU 103 is not degraded significantly.

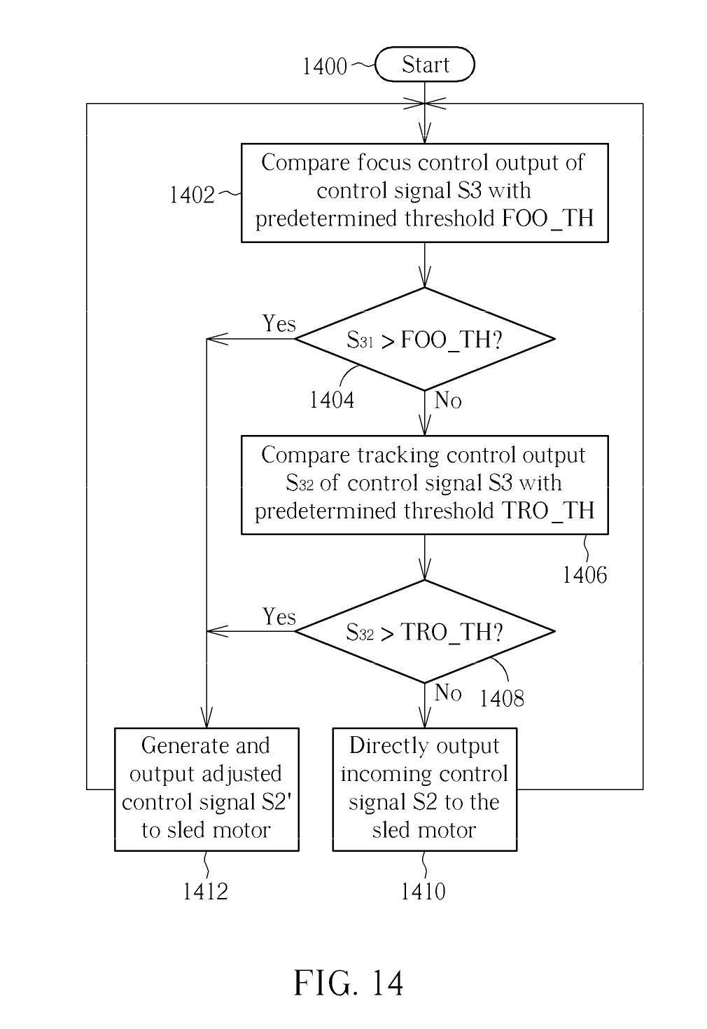

FIG. 14 is a flowchart illustrating an exemplary method of controlling the optical storage apparatus by monitoring the signal level of the servo control signal. Provided that the result is substantially the same, the steps are not required to be executed in the exact order shown in FIG. 14. The exemplary method may include the following steps.

Step 1400: Start.

Step 1402: Compare the focus control output S₃₁ of the control signal S3 with the predetermined threshold FOO_TH.

Step 1404: Does the focus control output S₃₁ exceed the predetermined threshold FOO_TH? If yes, go to step 1412; otherwise, go to step 1406.

Step 1406: Compare the tracking control output S₃₂ of the control signal S3 with the predetermined threshold TRO_TH.

Step 1408: Does the tracking control output S₃₂ exceed the predetermined threshold TRO_TH? If yes, go to step 1412; otherwise, go to step 1410.

Step 1410: Directly output the incoming control signal S2 to the sled motor 104. Next, go to step 1402 to keep monitoring the control signal S3.

Step 1412: Generate and output the adjusted control signal S2′ to the sled motor 104. Next, go to step 1402 to keep monitoring the control signal S3.

It should be noted that the order of checking the focus control output S₃₁ and the tracking control output S₃₂ may be adjusted, depending upon actual design requirement/consideration. For example, in one alternative design, the step of checking the focus control output S₃₁ may be executed after it is determined that the tracking control output S₃₂ does not exceed the predetermined threshold TRO_TH. In another alternative design, the operation of comparing the focus control output S₃₁ with the predetermined threshold FOO_TH and the operation of comparing the tracking control output S₃₂ with the predetermined threshold TRO_TH may be executed in a parallel fashion. The same objective of detecting the occurrence of the control signal S3 larger than the predetermined threshold is achieved. As a person skilled in the art can readily understand details of each step shown in FIG. 13 after reading above paragraphs, further description is omitted here for brevity.

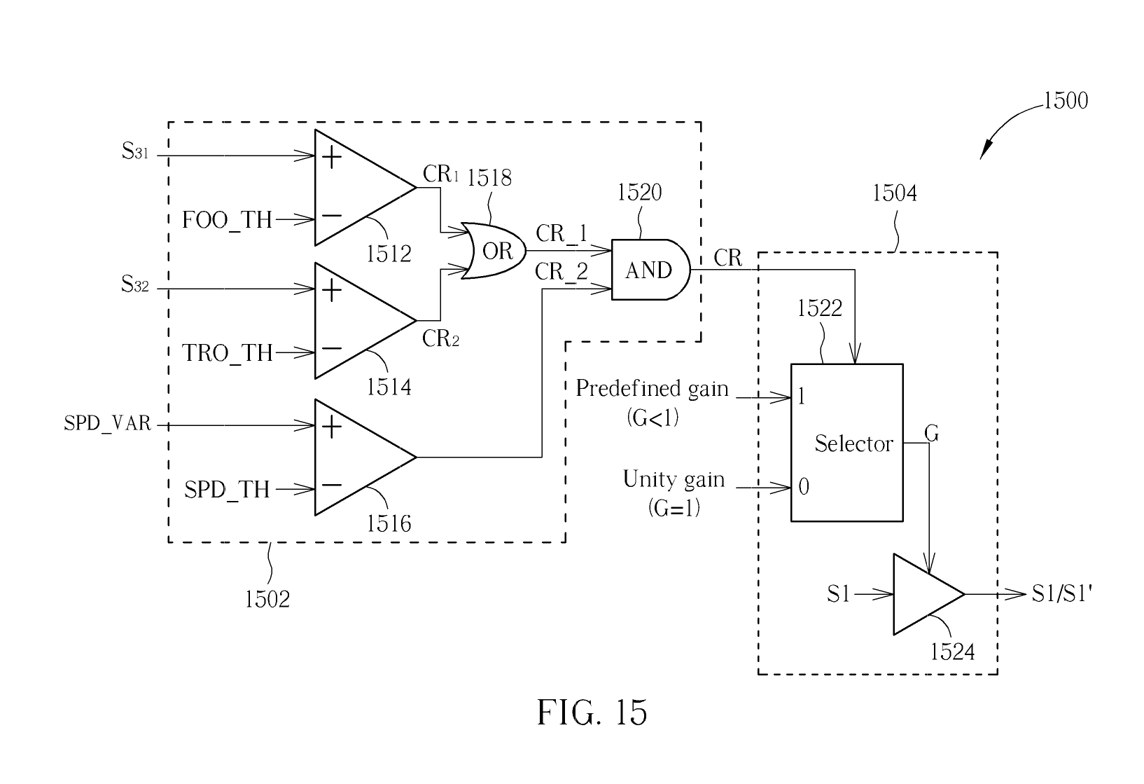

FIG. 15 is a diagram illustrating a second exemplary implementation of the output controller 1202 shown in FIG. 12 according to the present invention. The output controller 1202 shown in FIG. 12 may be realized by the hardware-based output controller 1500. As shown in FIG. 15, the output controller 1500 includes a comparing unit 1502 and an adjusting unit 1504. The comparing unit 1502 includes a plurality of comparators 1512, 1514, 1516 and a plurality of logic gates (e.g., an OR gate and an AND gate) 1518, 1520. The comparator 1512 is arranged to compare the focus control output S₃₁ of the control signal S3 with a predetermined threshold FOO_TH, and accordingly generate a comparison result CR₁. Specifically, when the focus control output S₃₁ exceeds the predetermined threshold FOO_TH, the comparison result CR₁ would carry one logic value “1”, and when the focus control output S₃₁ does not exceed the predetermined threshold FOO_TH, the comparison result CR₁ would carry another logic value “0”. The comparator 1514 is arranged to compare the tracking control output S₃₂ of the control signal S3 with a predetermined threshold TRO_TH, and accordingly generate a comparison result CR₂. Specifically, when the focus control output S₃₂ exceeds the predetermined threshold TRO_TH, the comparison result CR₂ would carry one logic value “1”, and when the focus control output S₃₂ does not exceed the predetermined threshold TRO_TH, the comparison result CR₂ would carry another logic value “0”. In this embodiment, the logic gate 1518 is an OR gate which performs an OR operation upon the comparison results CR₁ and CR₂ and accordingly generates a comparison result CR_1. Therefore, when at least one of the comparison results CR₁ and CR₂ carries the logic value “1”, the comparison result CR_1 would have the logic value “1”. In other words, only when each of the comparison results CR₁ and CR₂ carries the logic value “0”, the comparison result CR_1 would have the logic value “0”.

The comparator 1516 is arranged to compare a spindle speed variation SPD_VAR with a predetermined threshold SPD_TH, and accordingly generate a comparison result CR_2. Specifically, when the spindle speed variation SPD_VAR exceeds the predetermined threshold SPD_TH, the comparison result CR_2 would carry one logic value “1”, and when the spindle speed variation SPD_VAR does not exceed the predetermined threshold SPD_TH, the comparison result CR_1 would carry another logic value “0”. By way of example, but not limitation, the spindle speed variation SPD_VAR may be derived by monitoring the spindle acceleration/deceleration.

For example, the comparator 1516 may part of the spindle acceleration/deceleration detector 402 shown in FIG. 4. As mentioned above, a frequency generator (FG) signal S_{FG} generated from the spindle motor 102 may be used to monitor the rotational speed of the spindle. More specifically, the frequency of the FG signal S_{FG} is proportional to the rotational speed of the spindle. Thus, the frequency error (frequency variation) of the FG signal S_{FG} is also indicative of the spindle speed error (spindle speed variation), and may act as an input of the comparator 1516. Thus, when the frequency error (frequency variation) of the FG signal S_{FG} is found greater than a predetermined threshold value (e.g., SPD_TH) by the comparator 1516, it is determined that the spindle motor 102 is currently accelerating/decelerating its spindle rotation, and the comparison result CR_2 is set by the logic value “1” to indicate the occurrence of the spindle acceleration/deceleration. However, this is for illustrative purposes only, and is not meant to be a limitation of the present invention. Any means capable of directly/indirectly measuring the magnitude of the spindle speed variation SPD_VAR may be employed.

The logic gate 1520 is an AND gate which performs an AND operation upon the comparison results CR_1 and CR_2 and generates a comparison result CR as an output of the comparing unit 1502. Therefore, when at least one of the comparison results CR_1 and CR_2 carries the logic value “0”, the comparison result CR has the logic value “0”. In other words, only when each of the comparison results CR_1 and CR_2 carries the logic value “1”, the comparison result CR would have the logic value “1”.

In this embodiment, the adjusting unit 1304 is implemented by a selector 1522 and a variable gain amplifier 1524. The selector 1522 is controlled by the comparison result CR to output a selected gain setting G for configuring the variable gain amplifier 1524. The selector 1522 outputs a predetermined gain (e.g., G<1) as the selected gain setting when the comparison result CR has the logic value “1”, and outputs a unity gain (e.g., G=1) as the selected gain setting when the comparison result CR has the logic value “0”. Specifically, when at least one of the comparison results CR_1 and CR_2 carries the logic value “1” (i.e., at least one of the focus control output S₃₁ and tracking control output S₃₂ exceeds the corresponding predetermined threshold FOO_TH/TRO_TH) and the spindle speed variation SPD_VAR exceeds the corresponding predetermined threshold SPD_TH (i.e., the spindle is currently accelerating/decelerating), the selector 1522 outputs a reduced gain setting to the variable gain amplifier 1524, and the variable gain amplifier 1524 generates the adjusted control signal S1′ by referring to the reduced gain setting to apply a lower gain to the control signal S1. As the adjusted control signal S1′ would have a signal level not greater than that of the original control signal S1 during the time period in which the control signal S3 is found larger than a predetermined threshold and the spindle speed variation is found larger than a predetermined threshold. In this way, when defects are encountered by the OPU 103 during the active period of the spindle motor 102, the consumed peak current/power is prevented from exceeding the maximum level that the power source of the optical storage apparatus 100 (e.g., an external optical disc drive) can afford. Besides, as no signal level reduction is made to the control signal S3, the read/write performance of the OPU 103 is not degraded significantly.

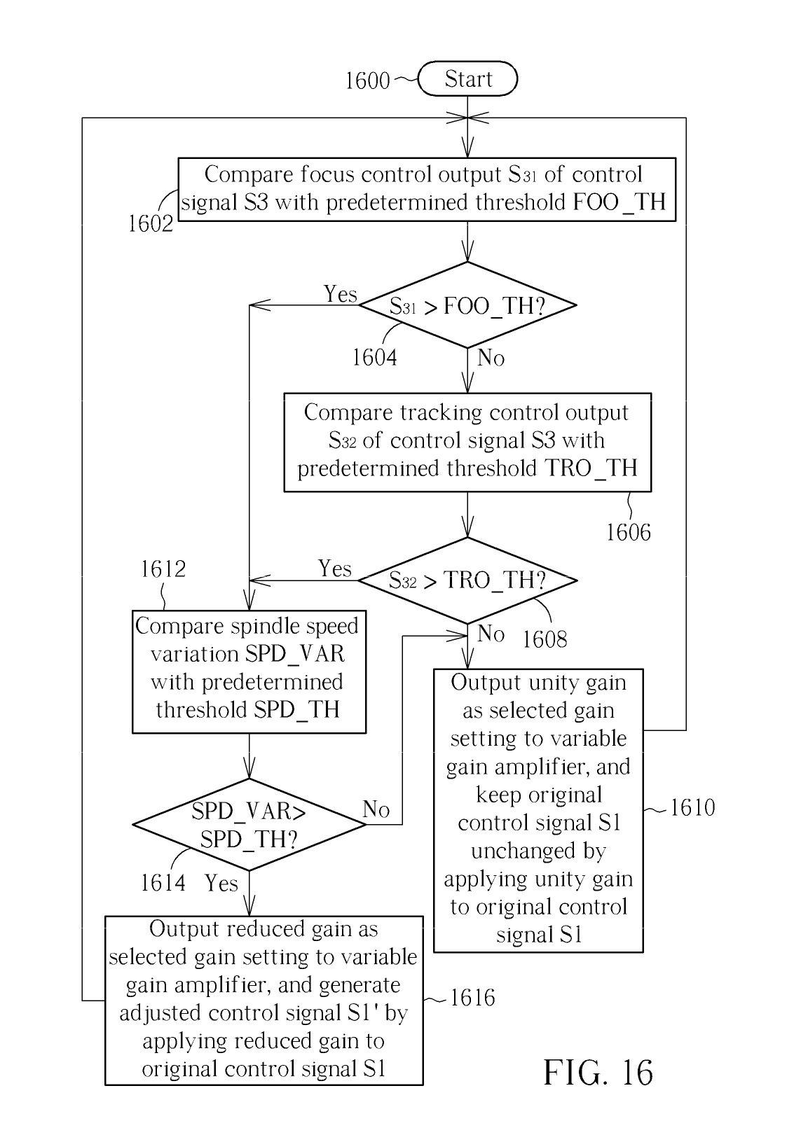

FIG. 16 is a flowchart illustrating another exemplary method of controlling the optical storage apparatus by monitoring the signal level of the servo control signal. Provided that the result is substantially the same, the steps are not required to be executed in the exact order shown in FIG. 16. The exemplary method may include the following steps.

Step 1600: Start.

Step 1602: Compare the focus control output S₃₁ of the control signal S3 with the predetermined threshold FOO_TH.

Step 1604: Does the focus control output S₃₁ exceed the predetermined threshold FOO_TH? If yes, go to step 1612; otherwise, go to step 1606.

Step 1606: Compare the tracking control output S₃₂ of the control signal S3 with the predetermined threshold TRO_TH.

Step 1608: Does the tracking control output S₃₂ exceed the predetermined threshold TRO_TH? If yes, go to step 1612; otherwise, go to step 1610.

Step 1610: Output the unity gain as the selected gain setting to the variable gain amplifier, and keep the original control signal S1 unchanged by applying the unity gain to the original control signal S1. Next, go to step 1602 to keep monitoring the control signal S3.

Step 1612: Compare the spindle speed variation SPD_VAR with the predetermined threshold SPD_TH.

Step 1614: Does the spindle speed variation SPD_VAR exceed the predetermined threshold SPD_TH? If yes, go to step 1616; otherwise, go to step 1610.

Step 1616: Output the reduced gain as the selected gain setting to the variable gain amplifier, and generate the adjusted control signal S1′ by applying the reduced gain to the original control signal S1. Go to step 1602 to keep monitoring the control signal S3.

It should be noted that the order of checking the focus control output S₃₁, checking the tracking control output S₃₂ and checking the spindle speed variation SPD_VAR may be adjusted, depending upon actual design requirement/consideration. For example, in one alternative design, the step of checking the focus control output S₃₁ may be executed after it is determined that the tracking control output S₃₂ does not exceed the predetermined threshold TRO_TH. In another alternative design, the step of checking the focus control output S₃₁/tracking control output S₃₂ may be executed after it is determined that the spindle speed variation SPD_VAR exceeds the predetermined threshold SPD_TH. In yet another alternative design, the operation of comparing the focus control output S₃₁ with the predetermined threshold FOO_TH, the operation of comparing the tracking control output S₃₂ with the predetermined threshold TRO_TH, and the operation of comparing the spindle speed variation SPD_VAR with the predetermined threshold SPD_TH may be executed in a parallel fashion. The same objective of detecting the occurrence of the control signal S3 larger than a predetermined threshold as well as the spindle speed variation larger than a predetermined threshold is achieved. As a person skilled in the art can readily understand details of each step shown in FIG. 16 after reading above paragraphs, further description is omitted here for brevity.

The control module 1200 may use a focus clamping value to limit the maximum signal level of the focus control output S₃₁, thus protecting the object lens of the OPU 103 from moving beyond an acceptable vertical range. In addition, the control module 1200 may use a tracking clamping value to limit the maximum signal level of the tracking control output S₃₂, thus protecting the object lens of the OPU from moving beyond an acceptable horizontal range. It should be noted that the predetermined threshold FOO_TH in above examples shown in FIG. 13 and FIG. 15 is not required to be exactly the same as the focus clamping value, and/or the predetermined threshold TRO_TH in above examples shown in FIG. 13 and FIG. 15 is not required to be exactly the same as the tracking clamping value. This may improve the flexibility in the hardware/firmware design. Besides, the predetermined threshold FOO_TH in FIG. 13 may be identical to or different from the predetermined threshold FOO_TH in FIG. 15, and the predetermined threshold TRO_TH in FIG. 13 may be identical to or different from the predetermined threshold TRO_TH in FIG. 15.

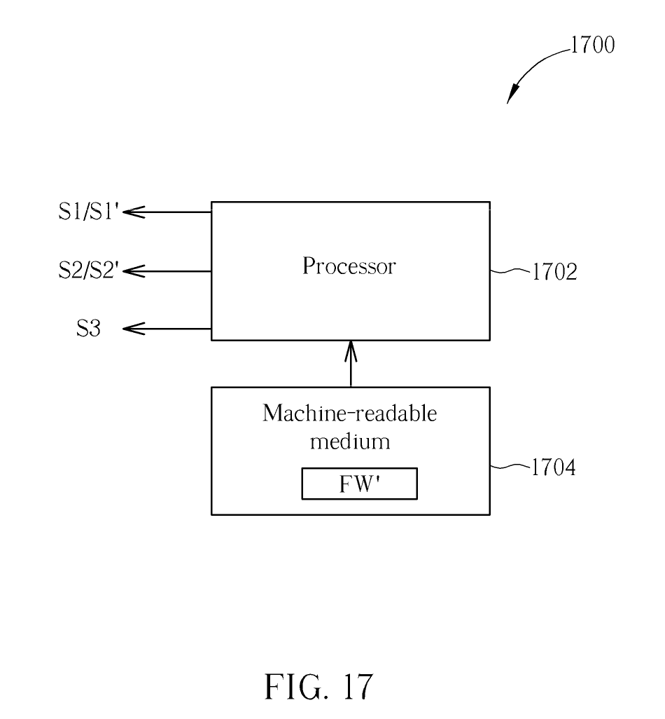

Regarding the exemplary embodiment shown in FIG. 12, the spindle motor controller 112, the servo actuator controller 116, the sled motor controller 114, and the output controller 1202 may be implemented by pure hardware. That is, the adjustments made to the control signals S1 and S2 are controlled by hardware elements. However, in an alternative design, the adjustments made to the control signals S1 and S2 may be controlled by a processor executing a program code. Please refer to FIG. 17, which is a diagram illustrating a firmware-based implementation of the control module 1200 shown in FIG. 12 according to an exemplary embodiment of the present invention. The firmware-based control module 1700 includes a processor 1702 and a non-transitory machine-readable medium 1704 having a program code (e.g., firmware FW′ of the optical storage apparatus 100) stored therein. By way of example, but not limitation, the machine-readable medium 1704 may be a non-volatile storage device such as a flash memory. When loaded and executed by the processor 1702, the firmware FW′ causes the processor 1702 to monitor the signal level of the control signal S3 for selectively adjusting the control signal S1/S2, thereby preventing the peak current/power consumption of the optical storage apparatus 10 from exceeding the acceptable level.

As the firmware FW′ executed by the processor 1702 functions as the hardware-based control module 1200 shown in FIG. 12, the program code (e.g., firmware FW′ of the optical storage apparatus 100), when executed by the processor 1702, would cause the processor 1102 to perform at least the following steps for peak power/current reduction: driving a first mechanical mechanism (e.g., the servo actuator 106) of the optical storage apparatus 100 by applying a first control signal (e.g., S3) to the first mechanical mechanism; driving a second mechanical mechanism (e.g., the spindle motor 102 or the sled motor 104) of the optical storage apparatus 100 by applying a second control signal (e.g., S1 or S2) to the second mechanical mechanism; comparing the first control signal with a predetermined threshold (e.g., comparing the focus control output S₃₁ with the predetermined threshold FOO_TH and/or comparing the tracking control output S32 with the predetermined threshold TRO_TH), and accordingly generating a comparison result; and selectively adjusting the second control signal according to at least the comparison result. As a person skilled in the art can readily understand the operation of the program code executed by the processor 1702 after reading above paragraphs directed to the exemplary embodiment shown in FIG. 13/FIG. 15, further description is omitted here for brevity.

In above exemplary embodiments, the proposed control scheme is employed in an optical storage apparatus. However, this is for illustrative purposes only, and is not meant to be a limitation of the present invention. That is, the proposed control scheme of the present invention may be applied to any electronic device having a plurality of mechanical mechanisms. Specifically, the aforementioned optical storage apparatus is merely an example of the electronic device to which the proposed control scheme is applied. Hence, the term “optical storage apparatus” used in above description may be replaced with the term “electronic device” without departing from the spirit of the present invention. With the help of the proposed control scheme, the same objective of preventing the peak power/current consumption of the electronic device from exceeding a permitted level is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling an electronic device which has a plurality of mechanical mechanisms including at least a first mechanical mechanism and a second mechanical mechanism, the method comprising:
driving the first mechanical mechanism by applying a first control signal to the first mechanical mechanism;
driving the second mechanical mechanism by applying a second control signal to the second mechanical mechanism;
comparing the first control signal with a first predetermined threshold, and accordingly generating a first comparison result; and
selectively adjusting the second control signal according to at least the first comparison result.

2. The method of claim 1, wherein the step of selectively adjusting the second control signal comprises:
when the first comparison result indicates that the first control signal exceeds the first predetermined threshold, reducing the second control signal to generate an adjusted first control signal to the second mechanical mechanism.

3. The method of claim 2, wherein the step of reducing the second control signal comprises:
generating the adjusted first control signal by holding the second control signal at a predefined level.

4. The method of claim 2, wherein the step of reducing the second control signal comprises:
generating the adjusted first control signal by stopping the second control signal from being applied to the second mechanical mechanism such that the adjusted second control signal has no control over the second mechanical mechanism.

5. The method of claim 1, wherein the second mechanical mechanism is a spindle motor, and the method further comprises:
comparing a spindle speed variation with a second predetermined threshold, and accordingly generating a second comparison result;
wherein the step of selectively adjusting the second control signal comprises:
selectively adjusting the second control signal according to the first comparison result and the second comparison result.

6. The method of claim 5, wherein the step of selectively adjusting the second control signal comprises:
when the first comparison result indicates that the first control signal exceeds the first predetermined threshold and the second comparison result indicates that the spindle speed variation exceeds the second predetermined threshold, reducing the second control signal by lowering a gain applied to the second control signal.

7. The method of claim 1, wherein the first mechanical mechanism is part of a servo actuator.

8. The method of claim 7, wherein the first mechanical mechanism is arranged for focus control.

9. The method of claim 7, wherein the first mechanical mechanism is arranged for tracking control.

10. The method of claim 1, wherein the second mechanical mechanism is a sled motor.

11. The method of claim 1, wherein the second mechanical mechanism is a spindle motor.

12. An electronic device, comprising:
a plurality of mechanical mechanisms, including at least a first mechanical mechanism and a second mechanical mechanism; and
a control module, electrically connected to at least the first mechanical mechanism and the second mechanical mechanism, comprising:
a first controller, arranged for driving the first mechanical mechanism by applying a first control signal to the first mechanical mechanism;
a second controller, arranged for driving the second mechanical mechanism by applying a second control signal to the second mechanical mechanism; and
an output controller, comprising:
a first comparing unit, arranged for comparing the first control signal with a first predetermined threshold, and accordingly generating a first comparison result; and
an adjusting unit, arranged for selectively adjusting the second control signal according to at least the first comparison result.

13. The electronic device of claim 12, wherein when the first comparison result indicates that the first control signal exceeds the first predetermined threshold, the adjusting unit reduces the second control signal to generate an adjusted first control signal to the second mechanical mechanism.

14. The electronic device of claim 13, wherein the adjusting unit generates the adjusted first control signal by holding the second control signal at a predefined level.

15. The electronic device of claim 13, wherein the adjusting unit generates the adjusted first control signal by stopping the second control signal from being applied to the second mechanical mechanism such that the adjusted second control signal has no control over the second mechanical mechanism.

16. The electronic device of claim 12, wherein the second mechanical mechanism is a spindle motor, and the output controller further comprises:
a second comparing unit, arranged for comparing a spindle speed variation with a second predetermined threshold, and accordingly generating a second comparison result, where the adjusting unit selectively adjusts the second control signal according to the first comparison result and the second comparison result.

17. The electronic device of claim 16, wherein when the first comparison result indicates that the first control signal exceeds the first predetermined threshold and the second comparison result indicates that the spindle speed variation exceeds the second predetermined threshold, the adjusting unit reduces the second control signal by lowering a gain applied to the second control signal.

18. The electronic device of claim 12, wherein the first mechanical mechanism is part of a servo actuator.

19. The electronic device of claim 18, wherein the first mechanical mechanism is arranged for focus control.

20. The electronic device of claim 18, wherein the first mechanical mechanism is arranged for tracking control.

21. The electronic device of claim 12, wherein the second mechanical mechanism is a sled motor.

22. The electronic device of claim 12, wherein the second mechanical mechanism is a spindle motor.

23. A non-transitory machine-readable medium, storing a program code, when executed by a processor, causing the processor to perform following steps:
driving a first mechanical mechanism of an electronic device by applying a first control signal to the first mechanical mechanism;
driving a second mechanical mechanism of the electronic device by applying a second control signal to the second mechanical mechanism;
comparing the first control signal with a predetermined threshold, and accordingly generating a comparison result; and
selectively adjusting the second control signal according to at least the comparison result.
